(19) United States
(12) Patent Application Publication
(10) Pub. No.: US 2026/0117806 A1
(43) Pub. Date: Apr. 30, 2026

(54) SECURING BRACKET

(71) Applicant: Christian Luna, Columbus, OH (US)

(72) Inventor: Christian Luna, Columbus, OH (US)

(21) Appl. No.: 19/005,709

(22) Filed: Dec. 30, 2024

Related U.S. Application Data
(60) Provisional application No. 63/623,215, filed on Jan. 20, 2024.

(51) Int. Cl. F16B 5/02; A01G 9/28

(52) U.S. Cl. CPC F16B 5/0216; A01G 9/28; F16B 2200/67

(57) ABSTRACT

A securing bracket and system are provided. The securing bracket is preferably used to secure two side panels of a housing together. The securing bracket is especially suitable for making housings of different shapes by allowing the side panels to be secured in a parallel or a perpendicular manner. The panels and securing brackets may be used to, for example, create a garden bed.

### CROSS REFERENCE TO RELATED APPLICATIONS

The following application is a based on and claims the priority benefit of U.S. provisional application Ser. No. 63/623,215 filed Jan. 20, 2024 currently co-pending; the entire content of which is incorporated by reference.

### BACKGROUND OF THE INVENTION

A securing bracket and system are provided. The securing bracket is preferably used to secure two side panels of a housing together. The securing bracket is especially suitable for making housings of different shapes by allowing the side panels to be secured in a parallel or a perpendicular manner. The panels and securing brackets may be used to, for example, create a garden bed.

Panels for garden beds are known. For example, US Publication No.: 20230116445 to Xiong discloses an angled joint panel and a garden bed therewith. The angled joint panel comprise a first wing comprising a plurality of sections; a second wing comprising a plurality of sections; a backbone hinge adjoining the first wing and the second wing; and an angled formed between the first wing and the second wing ranges between about 1 to about 359 degrees.

Further, U.S. Pat. No. 8,839,552 to Hudson discloses a gardening system includes a raised garden bed, the raised garden bed including a garden box having a soil retaining area for plantings. Garden box includes side walls detachably attached together at adjacent free ends forming a corner. A weed barrier provided which extends between the front, back, left, and right side walls of the garden box, and is located at a lower portion of garden box below the soil-retaining area, and weed barrier extends up the side walls up to the height of the side walls. A sprinkler system with sprinklers is provided and can be coupled to a garden hose. Rods are provided having a length the same as the height of the side walls, for holding the garden box together and so that the garden system can be placed on a non-soil surface, such as a deck or the gardener's roof.

Still further, U.S. Pat. No. 10,820,578 to Harris discloses a garden pond with a bottomless in-ground garden-plant watering-well with a reinforced socketed base for inserting supporting twist-lock stems for aquatic plant-baskets and assorted aquatic fixtures such as fountains. The in-ground garden-plant watering-well is part of the garden pond's outer wall and is open at both ends and is both functional and decorative. This embodiment also consists of a plant-container that has an above ground-level portion and a below-ground-level portion. The above ground-level portion is the watering-well, and the below-ground-level portion is the well-barrel. The aquatic garden pond feature can be set into the ground, and its rim is reinforced to support additional attachable in-ground garden-plant watering-wells.

However, these patent documents fail to describe a securing bracket for a garden bed which is easy to use. Further, these patents fail to provide for a securing bracket which allows a user to secure side panels in a parallel or a perpendicular manner.

### SUMMARY OF THE INVENTION

A securing bracket and system are provided. The securing bracket is preferably used to secure two side panels of a housing together. The securing bracket is especially suitable for making housings of different shapes by allowing the side panels to be secured in a parallel or a perpendicular manner. The panels and securing brackets may be used to, for example, create a garden bed.

An advantage of the present securing bracket is that the present securing bracket may allow a user to design a housing unit quickly.

Another advantage of the present securing bracket is that the present securing bracket may allow a user to create a numerous housing designs.

Yet another advantage of the present securing bracket is that the present securing bracket is durable.

Another advantage of the present securing bracket is that the present securing bracket has expansion braces for added support and to connect additional units.

Yet another advantage of the present securing bracket is that the present securing bracket allows a user to exponentially create additional raised beds by incorporating more than one kit. For example, two kits can make three raised beds. Three kits can make five raised beds. Four kits can make seven raised beds.

For a more complete understanding of the above listed features and advantages of the securing bracket device reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a front of the securing bracket in one embodiment.

FIG. 2 illustrates a top view of the securing bracket in one embodiment.

FIG. 3 illustrates a front view of one of the housing panels.

FIG. 4 illustrates an assembled housing utilizing both the parallel and the perpendicular securing capabilities of the securing bracket.

FIG. 5 illustrates multiple independent garden bed sets used together to make a garden bed with a greater number of sections than the total number of sets purchased.

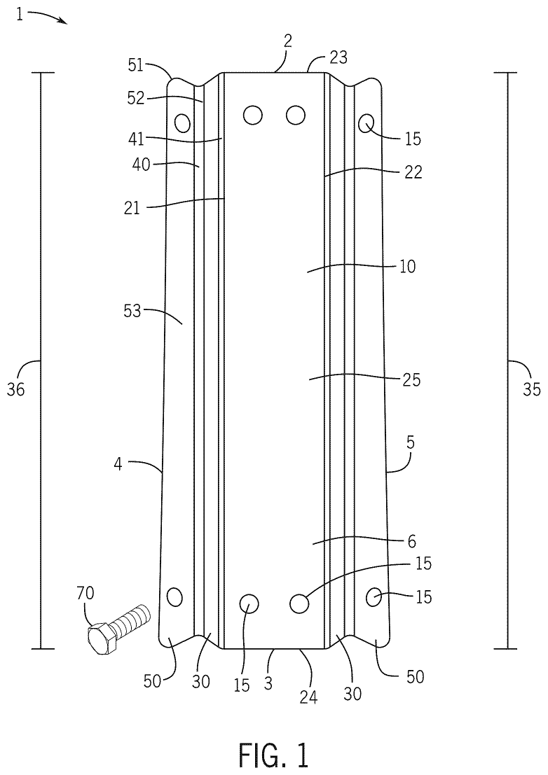

### DETAILED DESCRIPTION OF THE PREFERRED EMBODIMENTS

A securing bracket and system are provided. The securing bracket is preferably used to secure two side panels of a housing together. The securing bracket is especially suitable for making housings of different shapes by allowing the side panels to be secured in a parallel or a perpendicular manner. The panels and securing brackets may be used to, for example, create a garden bed.

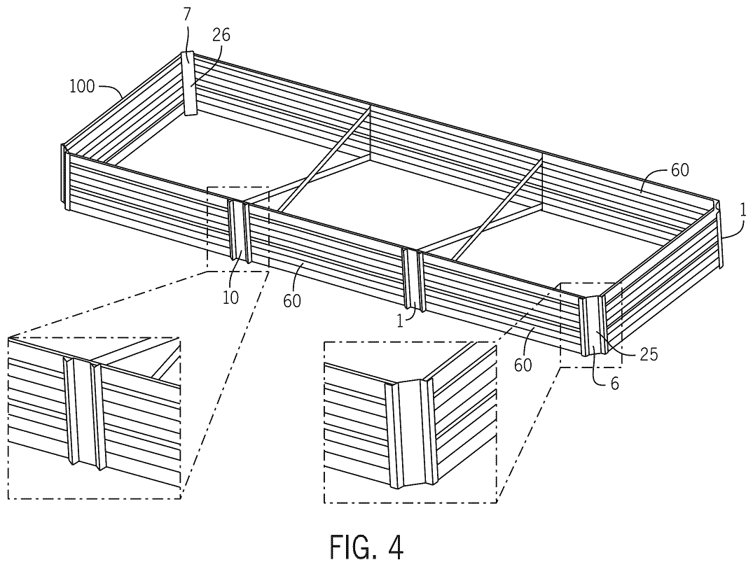

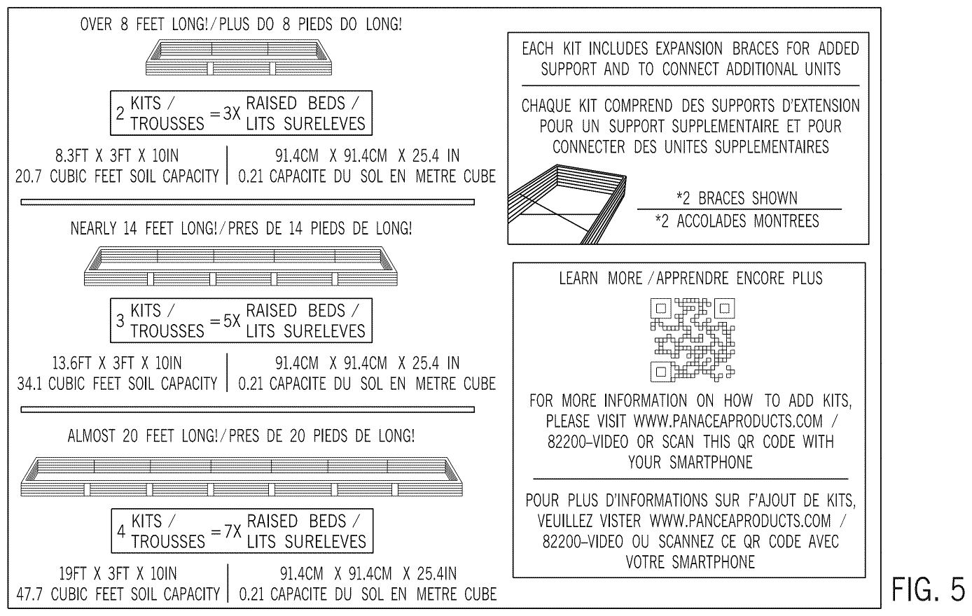

In an embodiment, a securing bracket 1 is provided. The securing bracket 1 may have a main panel section 10 and at least one inner elongated planar surface 30 and at least one outer elongated planar surface 50. The securing bracket 1 may be “bi-directional” as described below. The securing bracket 1 may have a top 2, a bottom 3, a first side 4, a second side 5, a front 6 and a back 7 (FIG. 4). Preferably the securing bracket 1 is made of a durable material such as a metal or a plastic. The front 6 of the main housing 10 of the securing bracket 1 is preferably rectangular in shape; although alternative shapes may be used. A plurality of holes 15 (or openings) may be present on the front of the main panel section 10. Preferably, there are at least four holes 15 as shown in the figures, located near the corner of the rectangular-shaped main panel 10. Alternative number of holes 15 may also be used.

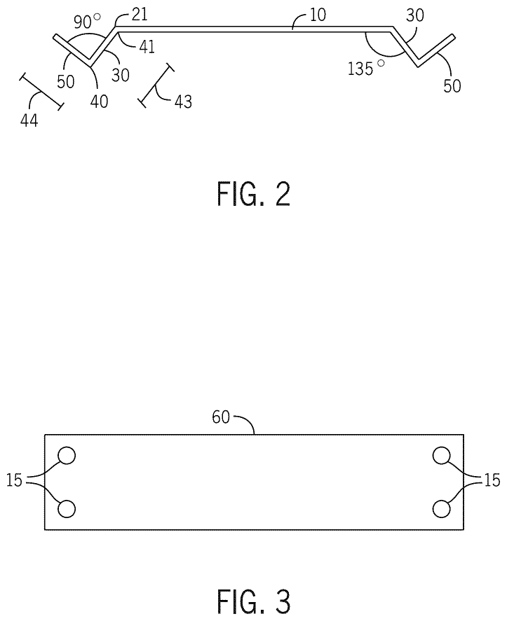

The front main panel 10 may have a first side 21, a second side 22, a top edge 23 a bottom edge 24, a front 25 and a back 26. Extending from the first side 21 and the second side 22 of the front main panel 10 may be the inner elongated planar surfaces 30. Each inner elongated planar surface 30 may have a length 35 equal to a length 36 of the front main panel 10. The inner elongated planar surfaces 30 may extend backward from the front main panel 10 at approximately, but preferably precisely, a one hundred- and thirty-five-degree angle as shown in FIG. 2.

The inner elongated planer surface 30 may have a first side 40 and a second side 41. The distance from the first side 40 to the second side 41 of the inner elongated planar surface 30 may define a width 43 of the inner elongated planar surface 30. The second side 41 of the inner elongated planar surface 30 may be attached to the first side 21 of the main body panel 10. Extending from the first side 40 of the inner elongated planar surface 30 may be an outer elongated planar surface 50 having a width 44 identical to the width 43 of the inner elongated planar surface 30. Preferably, the inner elongated planar surface 30 is substantially the same size and shape as the outer elongated planar surface 50.

In an embodiment, the inner elongated planar surface 30 lacks holes. The outer elongated planar surface 50 preferable has at least two holes 15. The outer elongated planar surface 50 may have a first side 51, a second side 52 and a front 53. Preferably, the second side 52 of the outer elongated planar surface 50 is connected to the first side 40 of the inner elongated planar surface 30.

A first housing panel 60 (FIG. 3) may be connected to the securing bracket 1. The housing panels 60 may have a plurality of holes 15. Preferably, a first housing panel 60 is temporarily and securely connected on one side of the securing bracket 1 and a second housing panel 60 is connected to the opposing side of the securing bracket 1. More specifically, in use, the securing bracket 1 is located between two housing panels 60 and acts as a connector unit to connect two housing panels 60 together. Further, in use, a plurality of securing brackets 1 and a plurality of housing panels 60 are connected together to form a single housing unit 100 as shown in FIG. 4.

A screw (or other securing device) 70 may be used to secure the housing panel 60 to the securing bracket 1. In particular, a plurality of screws 70 are inserted into the holes 15 of both the securing bracket 1 and the holes 15 of the housing panels 60 to hold the housing panels 60 to the securing brackets 1. Nuts (not shown) may be used to secure the screws 70.

Because the securing bracket 1 has two inner elongated planar surfaces 30 which are positioned at a one hundred and thirty-five degree angle, and because the those two inner elongated planar surfaces 30 each have their own outer elongated planar surfaces 50 positioned at approximately, but preferably precisely, a ninety degree angle, the same securing bracket 1 may be used to secure two housing panels 60 in either a parallel or a perpendicular orientation with respect to each other as shown in FIG. 4. The inner 30 and out 50 elongated panels are each approximately, but preferably precisely, perpendicular with respect to each other.

In an embodiment, a single garden bed set package may include multiple securing brackets 1 and four of the housing panels 60. As shown in FIG. 5, multiple packages of the garden bed set may be used together. In particular, a user may purchase, for example, two of the four-housing panel garden bed sets which therein allows the user to make three sections of attached garden beds. Similarly, buying three of the garden bed sets allows the user to make five connected raised bed sections. Still further, four sets will allow a user to make seven sections of a garden bed, etc. Other garden bed sets lack this feature because they lack the unique “bi-directional” securing bracket 1 connector of the present application, More specifically, other garden bed sets would require the purchase of three sets to make three complete bed sections, and seven sets would only make seven complete garden beds. The “bi-directional” securing bracket 1 connector described in this application allows for this unique arrangement.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1) A securing bracket comprising:
a main panel having a front, a back, a first side, a second side, a top and a bottom wherein the first side and the second side of the main panel have a length;
a first and a second inner elongated planar surface each having a front, a back, a first side, a second side, a top and a bottom wherein the first and the second inner elongated planar surfaces are connected to the first side and the second side of the main panel respectively;
wherein in the first side and the second side of both the first and the second inner elongated planar surface each have a length;
wherein the length of the first side and the second side of the main panel is equal to the length of the first side and the second side of the first and the second inner elongated planar surfaces;
a first and a second outer elongated planar surface each having a front, a back, a first side, a second side, a top and a bottom and wherein the first and the second outer elongated planar surfaces are connected to the first and the second inner elongated planar surfaces respectively;
at least one hole located on the main panel and at least one hole located on the first and the second outer elongated planar surfaces; and
wherein the shape and the size of the first inner elongated planar surface and the second inner elongated planar surfaces are equal to the shape and size of the first elongated planar surface and the second elongated planer surface.

2) The securing bracket of claim 1 wherein the first and the second inner elongated planar surfaces are secured to the main panel at a one hundred- and thirty-five-degree angle.

3) The securing bracket of claim 2 wherein the first and the second outer elongated planar surfaces are secured to the first and the second inner elongated planar surfaces at a ninety-degree angle.

4) A system for making a garden bed, the system comprising:
providing a bracket having a main panel having a front, a back, a first side, a second side, a top and a bottom wherein the first side and the second side of the main panel have a length;
providing a first and a second inner elongated planar surface each having a front, a back, a first side, a second side, a top and a bottom wherein the first and the second inner elongated planar surfaces are connected to the first side and the second side of the main panel;
providing a first and a second outer elongated planar surface each having a front, a back, a first side, a second side, a top and a bottom and wherein the first and the second outer elongated planar surfaces are connected to the first and the second inner elongated planar surfaces;
wherein in the first side and the second side of both the first and the second inner elongated planar surface each have a length;
wherein the length of the first side and the second side of the main panel is equal to the length of the first side and the second side of the first and the second inner elongated planar surfaces;
wherein at least one hole is located on the main panel and at least one hole is located on the first and the second outer elongated planar surfaces;
providing a housing panel wherein the housing panel is secured to the main panel of the bracket or secured to the outer elongated planar surface by securing the housing panel to the hole of the main panel of the bracket or the hole of the outer elongated planar surface; and
wherein the shape and the size of the first inner elongated planar surface and the second inner elongated planar surfaces are equal to the shape and size of the first elongated planar surface and the second elongated planer surface.

5) The system for making a garden bed of claim 4 wherein the housing panel is secured to the bracket at a ninety-degree angle or at a one-hundred-and-eighty-degree angle.
